(19) United States
(12) Patent Application Publication
(10) Pub. No.: US 2026/0328734 A1
(43) Pub. Date: Oct. 22, 2026

(54) ACOUSTIC INSPECTION SYSTEM AND METHOD

(71) Applicant: Signal-Wife, LLC, Troy, MI (US)

(72) Inventor: Lingguang Chen, Novi, MI (US)

(73) Assignee: Signal-Wise, LLC, Troy, MI (US)

(21) Appl. No.: 19/181,754

(22) Filed: Apr. 17, 2025

(51) Int. Cl. G01N 29/44; G01N 29/46; G06N 3/0455

(52) U.S. Cl. CPC G01N 29/4463; G01N 29/4481; G01N 29/46; G06N 3/0455; G01N 2291/0289

(57) ABSTRACT

A method for fault detection and quality assessment using acoustic signals, includes, through one or more controllers, collecting acoustic signals from equipment undergoing inspection or a production process undergoing inspection, the acoustic signals containing background noise. The method further includes processing the acoustic signals through a noise reduction model to isolate target sound signals emitted by the equipment or the production process. In addition, the method includes extracting acoustic fingerprints from the isolated target sound signals. The method additionally involves inputting the acoustic fingerprints into a fault detection model and classifying the operational state of or detecting anomalies in the equipment or production process based on an output of the fault detection model.

### INTRODUCTION

This disclosure is in the field of systems and methods for inspecting the operation of machinery and equipment and verifying the accuracy of production processes.

### BACKGROUND

Traditional industrial fault detection systems may rely on vibration signals together with Fourier spectral analysis, which requires the installation of sensors such as accelerometers on the equipment surfaces. While this may be generally effective in controlled settings, this approach faces several challenges. First, the need for physical attachment increases intrusiveness and operational complexity, particularly for equipment with irregular or hard-to-access surfaces. Second, the additional hardware increases costs. Finally, the intrusive nature of vibration-based systems limits their adaptability in dynamic or high-throughput production environments. A challenge facing Fourier spectral analysis is that it struggles to produce meaningful results when the input data are contaminated by random background noise. This is because many/all background noises may be contained in the spectrum, which can distort the actual frequency contents and their amplitudes.

Acoustic signal-based fault detection has been proposed as a non-contact alternative, offering the potential to overcome some of these challenges. However, its practical application in industrial environments may be severely limited due to the presence of background noise. Noise interference often masks subtle fault indicators, diminishing detection accuracy of these methods. A possible mitigation strategy may involve the use of a soundproof enclosure or silos around the equipment. While this may be effective in reducing noise interferences to some extent, this approach may be costly and often impractical for many production lines, particularly those requiring open and flexible setups.

Conventional signal processing methods struggle to distinguish between normal operational noise and defect-related anomalies. As a result, they may overlook subtle fault patterns, particularly in complex industrial environments with significant noise interference. This limitation underscores the need for a more sensitive, adaptable, and cost-effective solution for fault detection and quality control.

### SUMMARY

A method for fault detection and quality assessment using acoustic signals, includes, through one or more controllers, collecting acoustic signals from equipment undergoing inspection or a production process undergoing inspection, the acoustic signals containing background noise. The method further includes processing the acoustic signals through a noise reduction model to isolate target sound signals emitted by the equipment or the production process. In addition, the method includes extracting acoustic fingerprints from the isolated target sound signals. The method additionally involves inputting the acoustic fingerprints into a fault detection model and classifying the operational state of or detecting anomalies in the equipment or production process based on an output of the fault detection model.

The method may include training the fault detection model using supervised learning with faulty and healthy samples of the target sound signals. The method may include training the fault detection model using unsupervised learning with only healthy samples of the target sound signals. The noise reduction model may use spectrogram representations of the acoustic signals as inputs and may output denoised spectrograms for downstream processing. The acoustic fingerprints may be generated by extracting features from at least two of time, frequency, and time-frequency domains, followed by dimensionality reduction.

The target sound signals may be emitted by assembly of an electrical connector. The target sound signals may be emitted by operation of an electric motor. The target sound signals may be emitted by operation of an electric power transformer.

A fault detection system for equipment or a production process that emits target sound signals includes a noise reduction model configured to isolate the target sound signals from background noise signals to result in isolated target sound signals. The system additionally includes a feature extraction module configured to generate acoustic fingerprints from the isolated target sound signals, wherein the feature extraction module is adapted to extract features in at least two of time, frequency, and time-frequency domains, and standardize the extracted features for comparability. The system also has a fault detection model trained to classify operational states or detect anomalies in the equipment or production process based on the acoustic fingerprints. In addition, the system includes a data processing pipeline enabling real-time processing of acoustic signals containing target sound signals from the equipment or production process and background noise signals for real-time fault detection of the equipment or production process.

The noise reduction model may include a two-dimensional convolutional neural network (“2D CNN”) encoder-decoder structure adapted to reduce or eliminate random background noise. The noise reduction model may have a hybrid structure combining a 2D CNN and Long Short-Term Memory (“LSTM”) network adapted to reduce or eliminate periodic or dynamic background noise.

The fault detection model may include a supervised learning model trained with data comprising healthy and faulty samples of target sound signals, capable of classifying fault types. The fault detection model may include an unsupervised learning model trained on healthy samples but not on faulty samples of target sound signals, to identify anomalies based on deviation from a normal operational profile.

The acoustic fingerprints may be generated through a process that includes extracting multi-dimensional features from the isolated sound signals, standardizing and fusing the features into a unified representation, and reducing the dimensionality of the representation using Principal Component Analysis (“PCA”) to form a compact acoustic fingerprint.

The system may also include a data collection module configured to collect clean acoustic signals in a noise-controlled environment to form a baseline database, collect noisy acoustic signals in a production environment to form a test run dataset, and align signals from the baseline dataset and the test run dataset using correlation-based alignment techniques.

In the system, the noise reduction model may be trained by minimizing reconstruction errors between noisy and clean spectrograms using a mean-squared error loss function.

A second fault detection system includes a noise reduction model operative to isolate target sound signals from equipment or a production process from background noise, the noise reduction model further comprising a two-dimensional convolutional neural network (“2D CNN”) encoder-decoder structure operative to reduce or eliminate random background noise. The 2D CNN encoder-decoder structure further includes: a encoder including a first convolutional layer followed by a first batch normalization and a first rectified linear unit (“ReLU”) activation function; a first pooling layer; a second convolutional layer followed by a second batch normalization and a second ReLU activation function; a second pooling layer; and a fully-connected layer operative to map the flattened feature map to a latent feature space. The encoder-decoder structure also includes a decoder that includes a fully-connected layer operative to reshape the latent features into a feature map; a transposed convolutional layer, followed by batch normalization and a third ReLU activation function; a second transposed convolutional layer; a regression layer; and an inverse STFT. The fault detection system further includes a feature extraction module operative to generate acoustic fingerprints from the isolated target sound signals. Additionally, the fault detection system includes a fault detection model trained to classify operational states or detect anomalies in the equipment or production process based on the acoustic fingerprints. Further, the fault detection system includes a data processing pipeline enabling real-time processing of acoustic signals for fault detection.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1A illustrates two unmated halves of an electrical connector, the quality of whose assembly may be diagnosed by a system and method according to the present disclosure.

FIG. 1B illustrates the assembled connector resulting from the assembly of the two unmated connector halves illustrated in FIG. 1A.

FIG. 2 is a diagram that illustrates the architecture of a noise reduction model for processing acoustic signals in a fault detection system and method according to the present disclosure.

FIG. 3 is a diagram that illustrates a 2D CNN Encoder-Decoder architecture used for training a noise reduction model.

FIG. 4 is a diagram that illustrates the architecture used for training a noise reduction model, combining a 2D CNN encoder-decoder and LSTM.

FIG. 5 is a diagram that illustrates a workflow for extracting acoustic fingerprints from clean target signals.

FIG. 6 is a diagram that illustrates the architecture of a fault detection moded using supervised learning.

FIG. 7 is a diagram that illustrates the architecture of a fault detection model using unsupervised learning.

FIG. 8A illustrates an electric motor whose operation may be diagnosed by a system and method according to the present disclosure.

FIG. 8B illustrates an electric power transformer whose operation may be diagnosed by a system and method according to the present disclosure.

FIG. 9 illustrates a system that may carry out the method described in the present disclosure.

FIG. 10 illustrates a data processing pipeline provided by the system and method of this disclosure, which enables real-time processing of acoustic signals containing target sound signals and background noise for fault detection of equipment or a production process.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the Claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

This disclosure introduces a system and method for fault detection and quality assessment in machinery, equipment, and production processes using acoustic signals. The system employs noise reduction techniques and machine learning algorithms to operate effectively in noisy industrial environments. The system and method operates in a non-contact manner. Included herein is a description of an exemplary workflow and components included in the system and method.

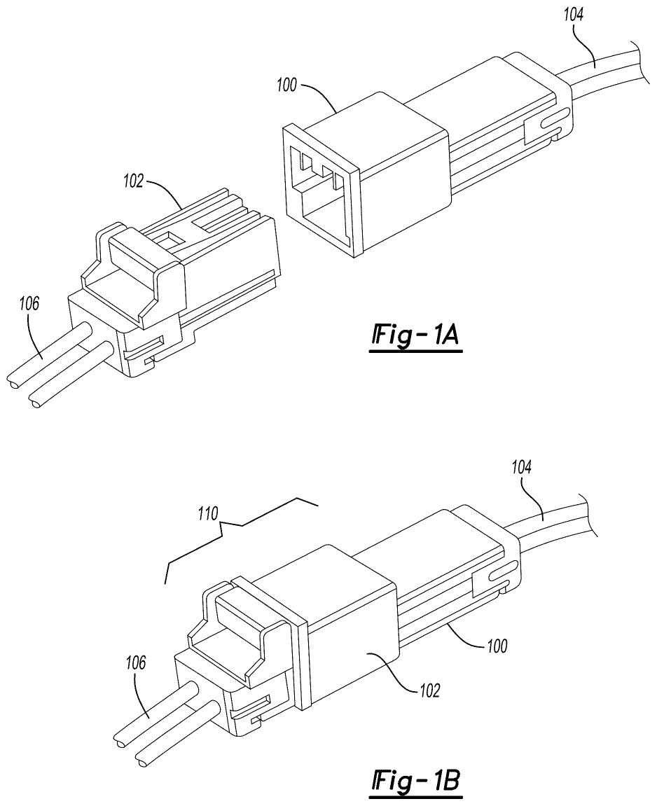

Refer first to FIG. 1A for an illustration of one application of the system and method of this disclosure. Illustrated there are two mating halves of an electrical connector. The mating halves may include connector half 100 and connector half 102. Each connector half has one or more wires, wires 104 and wires 106, respectively. When connector half 100 and connector half 102 are assembled (or mated) together, wires 104 and wires 106 are electrically connected. FIG. 1B shows mated connector 110, after mating of connector half 100 and connector half 102. When connector half 100 and connector half 102 are mated, that mating may emit an audible “CLICK” or other telltale target sound. Further, the audible sound of that “CLICK” may be different if connector half 100 and connector half 102 are properly mated (and wires 104 and wires 106 consequently correctly connected) than if connector half 100 and connector half 102 are incorrectly mated. An example of incorrect mating of connector half 100 and connector half 102 may be if the two connector halves are not fully pushed together.

As an example, connector half 100 and connector half 102 may be located on wire harnesses of an automobile or another manufactured product. The manufacturing of the product may occur in a noisy factory. Despite the efforts of an operator who assembles connector half 100 and connector half 102 to do so correctly, a large volume and/or throughput of manufacturing may result in some connectors not being mated correctly. If such incorrect mating results in lack of electrical connectivity between wires 104 and wires 106, that fault might be discoverable later in the production process of the manufactured product, such as through “end-of-line” electrical testing. However, at that point, the product may be fully assembled with mated connector 110 “buried” within the assembled product, and making a repair may be very inconvenient and inefficient. Further, an improperly mated connector may be mated enough to pass end-of-line electrical testing but still not be fully mated; over time, this connector may be a source of unreliability for the manufactured product, as the connector may come apart over time, such as while the manufactured product vibrates while in service. Therefore, detecting the improperly mated connector at the point where the connector is mated may be significantly advantageous.

By way of overview, the system operates by initially collecting a set of sample sound signals in a relatively quiet environment with minimal background noise. These signals serve as a baseline for the target sound. Subsequently, additional samples are collected in the real-world production environment, where significant background noise is present. The artificial intelligence (“AI”)-based noise reduction model is trained to distinguish the target sound from background noise by analyzing the statistical differences between these datasets. Unlike conventional denoising methods, which apply predefined filters, the proposed approach employs deep learning techniques to adaptively extract the target sound across varying noise conditions.

Once the noise reduction model is trained, it is applied to each signal collected in the noisy production environment to extract the target sound. This process effectively removes background noise, leaving a clean representation of the target sound signal.

The system then extracts acoustic fingerprints from each cleaned signal. These fingerprints consist of specific features that represent the unique characteristics of the sound, which may include frequency components, temporal patterns, and other distinguishing attributes. The extracted fingerprints are then used as inputs to train a deep learning model for fault detection or quality assessment.

The deep learning model is designed to recognize patterns and anomalies that indicate potential faults or deviations from expected quality standards. Through training on the extracted features, the model becomes capable of classifying signals as indicative of normal operation or potential defects. By leveraging this process, the system ensures accurate and reliable fault detection and quality assessment, even in environments with significant background noise.

The noise reduction model is specifically designed to extract clean target sound signals, addressing the challenge of background noise interference in acoustic signals generated by industrial equipment during operation. This helps ensure that subsequent fault diagnosis operations can be performed accurately and effectively.

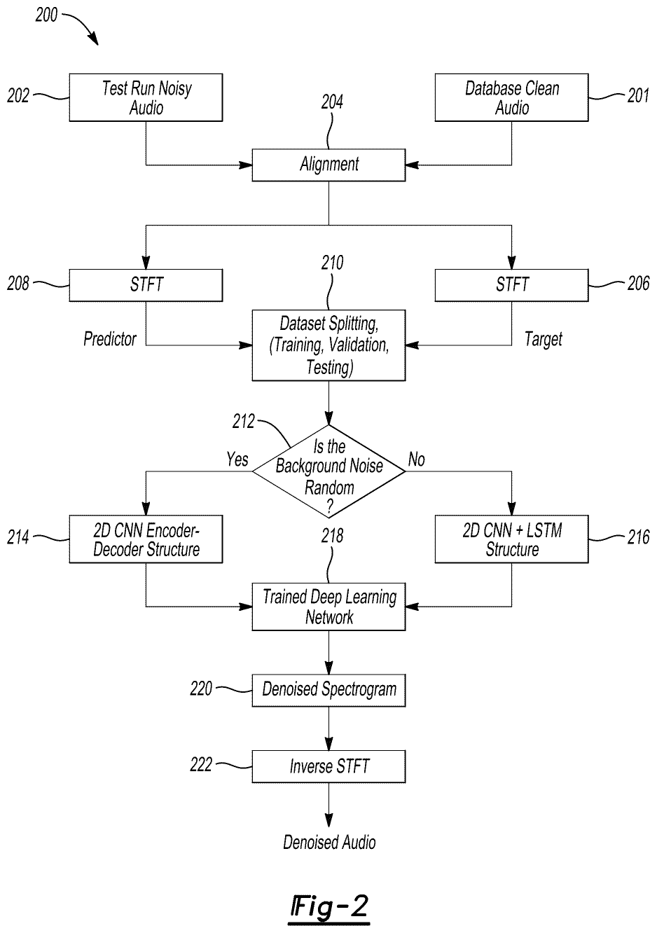

Refer now to FIG. 2, a block diagram of a noise reduction model 200. The data collection process involves two distinct datasets: Database 201 and the Test Run Dataset 202. Database 201 specifically refers to clean signals collected in noise-controlled, quiet environments. These signals accurately reflect the target sound characteristics, in this case the sound of connector half 100 and connector 102 being mated, without material interference. For cases where relocating equipment to a dedicated quiet room is not feasible, Database 201 may include signals recorded during scheduled downtime in a factory workshop, providing for minimal background noise. Meanwhile, Test Run Dataset 202 comprises signals captured during regular production operations in a production environment, which signals may be contaminated with background noise. The signals in Test Run Dataset 202 contain both the target sound and various types of background noise commonly present in industrial environments.

Once collected, data in Database 201 and Test Run Dataset 202 undergo preprocessing to prepare them for model training. One such preprocessing step involves aligning all signals within the two datasets (block 204) to achieve consistency. First, the dominant frequency of the target signal is identified using a Fourier analysis of the clean signals in Database 201. Based on this dominant frequency, a band-pass filter is designed and applied to all signals/data in both Database 201 and Test Run Dataset 202. This filtering process isolates the target frequency range, minimizing the influence of irrelevant noise components.

After filtering, the signals within both Database 201 and Test Run Dataset 202 are aligned (block 204) to a reference signal selected randomly from Database 201. This alignment is performed using a correlation-based method. Specifically, the cross-correlation of each signal with the reference signal is computed to identify the lag corresponding to the maximum correlation. This lag is then used to shift each signal to achieve temporal alignment with the reference. For segments of the signals that fall outside the aligned range due to this adjustment, the missing parts may be handled by padding with zeros. This padding provides that the signals maintain a uniform length after alignment, preserving consistency to achieve effective and accurate model training.

After alignment, the signals from Database 201 and Test Run Dataset 202 are transformed using short-time Fourier transform (“STFT”) 206 and STFT 208, respectively. STFT is a signal processing technique that analyzes how the frequency content of a non-stationary signal changes over time by applying the Fourier transform to short, overlapping segments of the signal.

The choice of the noise reduction model structure is selected based on the characteristics of the background noise in the production environment (block 212). If the noise is predominantly random background noise, a two-dimensional convolutional neural network (“2D CNN”) Encoder-Decoder structure 214 may be adopted. If the background noise exhibits periodic or dynamic characteristics, a hybrid structure 216 combining 2D CNN and Long Short-Term Memory (“LSTM”) may be utilized. Unlike conventional denoising filters, this approach may enable adaptive noise suppression, reduction, or elimination tailored to the operational environment, ensuring robust signal extraction across diverse industrial settings.

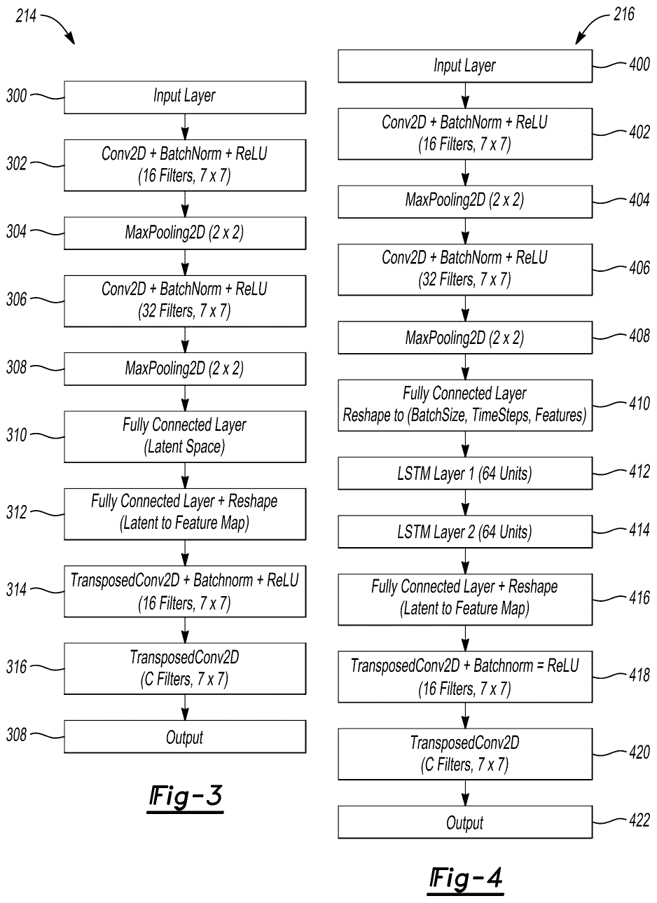

Refer additionally to FIG. 3. For the 2D CNN Encoder-Decoder structure 214, the input data 300 may be a two-dimensional spectrogram with dimensions [H, W, C], where H is the frequency dimension, W is the time dimension, and C is the number of channels, typically 1. The encoder may begin with an input layer of size [H, W, C]. The first convolutional layer 302 may apply a 7×7 kernel with 16 output channels, a stride of 1, and padding set to ‘same’. This may be followed by batch normalization and a ReLU activation function to extract basic spectral features. A 2×2 max pooling layer 304 with a stride of 2 and ‘same’ padding may reduce the spatial dimensions, enabling the network to focus on larger patterns. (In a convolutional neural network, a max pooling layer is a downsampling operation that reduces the spatial dimensions of feature maps by selecting the maximum value within each region, helping to retain important features while discarding less important details.) The second convolutional layer 306 may use a 7×7 kernel with 32 output channels, which may be similar in configuration to the first convolutional layer 302 and may be followed by another max pooling layer 308 that may be similar or identical to max pooling layer 304. These layers extract increasingly abstract and complex features. Finally, a fully connected layer 310 may map the flattened feature map to a latent feature space, followed by a Rectified Linear Unit (“ReLU”) activation function. (ReLU is a non-linear activation function used for deep neural networks in machine learning. It is also known as the rectifier activation function.) This latent representation is a compressed version of the input data that retains its essential features. Unlike conventional CNN architectures that rely on smaller 3×3 kernels, the choice of 7×7 kernels in this design may enhance the model's ability to capture broader frequency-time dependencies, making it more effective for acoustic signal processing in noise environments.

The decoder of 2D CNN Encoder-Decoder structure 214 may reconstruct the original signal by reversing the encoding process. It may start with a fully connected layer (block 312) that reshapes the latent features into a feature map of size [H/4, W/4, 32]. The first transposed convolutional layer (block 314) may use a 7×7 kernel with 16 output channels, a stride of 2, and ‘same’ padding, followed by batch normalization and a ReLU activation function. This layer may restore spatial resolution while maintaining the learned feature structure. The second transposed convolutional layer (block 316) may output C channels, recovering the feature map to its original dimensions. A regression layer may then output the denoised spectrogram (block 318), which may be converted back to the time domain using inverse STFT (iSTFT).

Refer additionally to FIG. 4. For the hybrid structure 216 combining 2D CNN and LSTM, the input data 400 may also be two-dimensional spectrogram with dimensions [H, W, C]. The encoder part (block 402, block 404, block 406, and block 408) may follow the same or a similar design as the 2D CNN Encoder-Decoder structure 214, extracting spatial features. The output of the encoder may be reshaped into a sequence of dimensions [batchSize, timeSteps, features] (block 410), where timeSteps corresponds to the temporal dimension, and features represent concatenated frequency features. This reshaped data may be passed into an LSTM layer, which processes the temporal sequences to extract dynamic characteristics. The LSTM can be a single-layer (comprising LSTM Layer 412) or multi-layer network (comprising, say, LSTM Layer 412 and LSTM Layer 414), with the number of hidden units adjusted based on task complexity. This temporal modeling capability may be beneficial for capturing periodic or dynamic noise patterns.

The decoder in the hybrid structure reconstructs the two-dimensional feature map from the LSTM output. A fully connected layer 416 reshapes the LSTM output into a feature map of size [H/4, W/4, 32]. This is followed by transposed convolutional layer 418 and transposed convolutional layer 420, which may be similar to those in the decoder of the 2D CNN Encoder-Decoder structure 214, to gradually restore the spatial resolution. The final output 422 is a denoised spectrogram that can be converted back to the time domain.

During model training, the data may be split or divided into three subsets: training, validation, and testing datasets (block 210, FIG. 2). Database 201 contributes the desired output signals, representing the clean target sound signals, while Test Run Dataset 202 provides the input signals, containing both target sounds and background noise. The training dataset is created by pairing signals from Test Run Dataset 202 as inputs with corresponding signals from Database 201 as the desired outputs. This provides that the training data comprehensively represents the range of operational and noise conditions. This dataset is used to optimize the model's parameters and ensure effective learning of signal isolation. The validation dataset, also derived from both Database 201 and Test Run Dataset 202, is used during training to evaluate the model's performance at different stages and fine-tune hyperparameters such as the learning rate and batch size. The testing dataset is reserved for evaluating the final performance of the trained model, providing an unbiased measure of its ability to generalize to unseen data.

The training process minimizes the reconstruction error, measured explicitly by the mean squared error (MSE) between the denoised and clean spectrograms. The optimization process employs the Adam optimizer with an initial learning rate of 0.001 and a batch size of 32, selected for its fast convergence and adaptive gradient updates, making it well-suited for non-stationary noise environments. These hyperparameters can be adjusted based on empirical tuning to optimize performance for specific industrial applications. Data augmentation is implemented by adding synthetic noise with predefined intensity levels and specific frequency characteristics to the training data. This systematic approach enhances the robustness and generalization capability of the noise reduction model.

The result of the above is a trained deep learning network 218.

After training, the noise reduction model may process noisy signals in real-time in production environments. The incoming signals from Test Run Dataset 202 are transformed into their spectrogram representations and fed into the trained model. The output is a clean (denoised) spectrogram 220 that is then converted back into the time domain via an inverse STFT 222 for downstream processing. This real-time processing capability allows the system to effectively handle dynamic and unpredictable noise conditions, ensuring reliable performance.

This noise reduction model is highly adaptable and versatile, with its design tailored to suit different industrial scenarios. The dual-structure approach allows the model to address a wide range of background noise characteristics, from random noise to complex time-varying patterns. The model employs advanced techniques to isolate target signals with high precision, ensuring accurate data for downstream fault detection and quality assessment systems. The integration of this model into industrial processes not only improves the reliability of acoustic-based monitoring systems but also expands their applicability in challenging environments.

In this disclosure, the term “acoustic fingerprint” refers to a compact representation derived from the fusion of multiple-dimensional features extracted from acoustic signals generated during the operation of industrial equipment or during an industrial process.

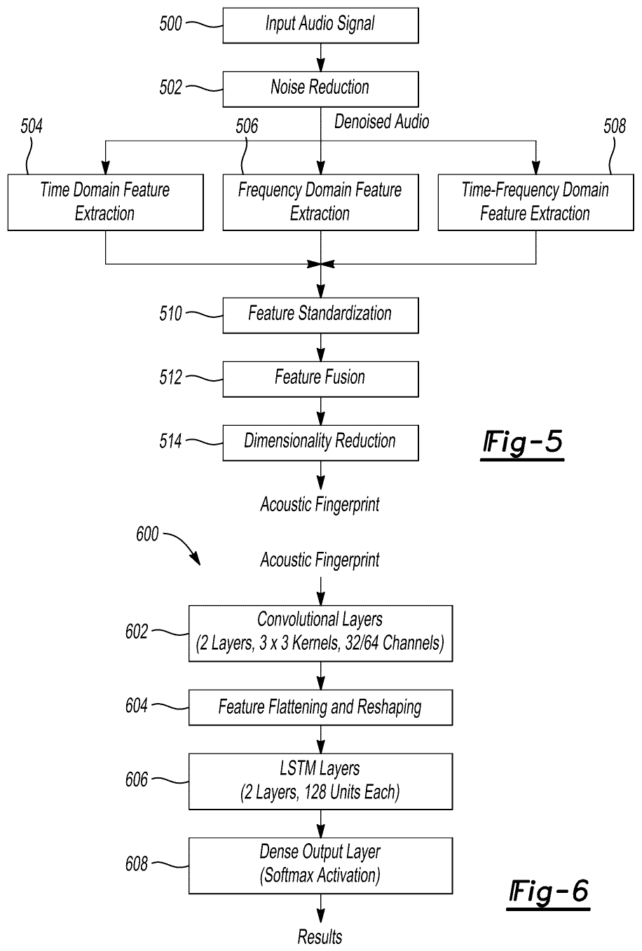

Refer to FIG. 5. An input audio signal 500 may undergo noise reduction 502 to result in denoised audio. The extraction of the acoustic fingerprint involves selecting specific features across multiple domains to provide a holistic representation of the signal.

In the time domain (block 504), the extracted features may include the mean amplitude of the signal, the standard deviation of the signal's amplitude, the peak value of the signal, the crest factor and the zero-crossing rate. These features may describe the basic dynamics, amplitude variations, and temporal behavior of the signal.

In the frequency domain (block 506), the extracted features may include the dominant frequency, the spectral entropy, the band energy within predefined frequency bands that are relevant to the equipment or process's operational characteristics, the harmonics of the dominant frequency, the spectral centroid, and the spectral bandwidth. These features may offer precise insights into frequency distribution patterns, enabling sensitive detection of subtle frequency anomalies associated with mechanical or operational faults.

For time-frequency analysis (block 508), STFT may be used to generate spectrograms, which capture the evolution of frequency components over time. Each spectrogram may be further analyzed to extract features such as the temporal changes in dominant frequencies, localized energy concentrations within specific time-frequency regions, and patterns indicative of transient events. This approach may enhance the acoustic fingerprint's capability to detect dynamic anomalies occurring over short durations. Block 504, block 506, and block 508 may collectively, in a subset, or individually be considered a feature extraction module.

After extracting these features from the time, frequency, and time-frequency domains (that is, multidimensionally), the next step (block 510) is to standardize the features to provide consistency and comparability. Each feature may be normalized to have zero mean and unit variance, mitigating the effects of differences in scale across features. Once standardized, the features may be fused (block 512) into a single unified representation by concatenating them into a high-dimensional feature vector. During the fusion process, domain-specific weighting may be applied to prioritize features with higher relevance based on prior knowledge or statistical significance. For instance, frequency domain features may receive higher weights when analyzing equipment with strong periodic behavior, while time-frequency features may be prioritized for transient signals.

To further enhance the representation and manage high dimensionality, Principal Component Analysis (“PCA”) may be applied to the fused feature vector. PCA may identify the principal components that capture most of the variance in the data, effectively reducing redundancy and noise in the feature set. This dimensionality reduction step (block 514) projects the high-dimensional data onto a lower-dimensional subspace, resulting in a compact and robust acoustic fingerprint that retains the essential characteristics of the original signal. Compared with alternative dimensionality reduction techniques, PCA offers computation simplicity and reliability for real-time industrial implementations.

The resulting compact acoustic fingerprint encapsulates the most informative and noise-resilient features of the target signal in a computationally efficient format, significantly enhancing fault detection accuracy and reliability in noisy, real-world industrial environments.

The acoustic fingerprint serves as the input to the noise reduction model, which is designed to classify operational states and detect potential anomalies. The noise reduction model addresses two distinct scenarios. In the first scenario, where both healthy and faulty samples are available, supervised learning techniques may be applied. In the second scenario, where only healthy samples are available due to the difficulty of obtaining faulty data, unsupervised learning methods may be employed.

In a case where both healthy and faulty samples are available, the fault detection model may employ a supervised learning approach, being trained with data comprising healthy and faulty samples of target sound signals and therefore being capable of classifying fault types. Refer to FIG. 6, a block diagram of a fault detection model 600. The model leverages a hybrid architecture that combines Convolutional Neural Networks (CNNs) and Long Short-Term Memory (LSTM) networks. The CNN component 602 begins with an input layer designed to accept acoustic fingerprints in a two-dimensional format ([H, W, C], where H represents height, W represents width, and C represents the number of channels). This input is processed through two convolutional layers (block 602). The first convolutional layer uses a 3×3 kernel with 32 output channels, ReLU activation, and a stride of 1, followed by batch normalization to stabilize training and a max-pooling layer with a pooling size of 2×2. The second convolutional layer uses a 3×3 kernel with 64 output channels, ReLU activation, and a stride of 1, followed by another max-pooling layer with a pooling size of 2×2. These layers extract spatial features and reduce the dimensionality of the input while preserving the essential patterns within the data.

After feature extraction, the output of the CNN is flattened and reshaped (block 604) into a sequential format suitable for temporal modeling. This reshaped data is fed into an LSTM network 606, which may comprise two or more stacked LSTM layers, each with 128 hidden units. These layers capture temporal dependencies and dynamic variations in the input data, enabling the network to process sequential information effectively. Dropout layers are incorporated between LSTM layers to prevent overfitting, and a dense output layer 608 with softmax activation may be used at the output stage to classify the signals into healthy or faulty categories. (The “softmax” function, which may be used in the final layer of a neural network model for classification tasks, may convert raw output scores —also known as logits —into probabilities by taking the exponential of each output and normalizing these values by dividing by the sum of all the exponentials. This process ensures the output values are in the range (0,1) and sum up to 1, making them interpretable as probabilities.) The training process may utilize a cross-entropy loss function and is optimized using the Adam optimizer, an optimization algorithm that can be used instead of the classical stochastic gradient descent procedure to update network weights iterative based in training data. Because of its fast convergence and robustness across problems, the Adam optimization algorithm may be effective in deep learning. Once trained, this hybrid CNN-LSTM model efficiently classifies incoming signals into healthy or faulty states, enabling real-time fault detection and diagnosis.

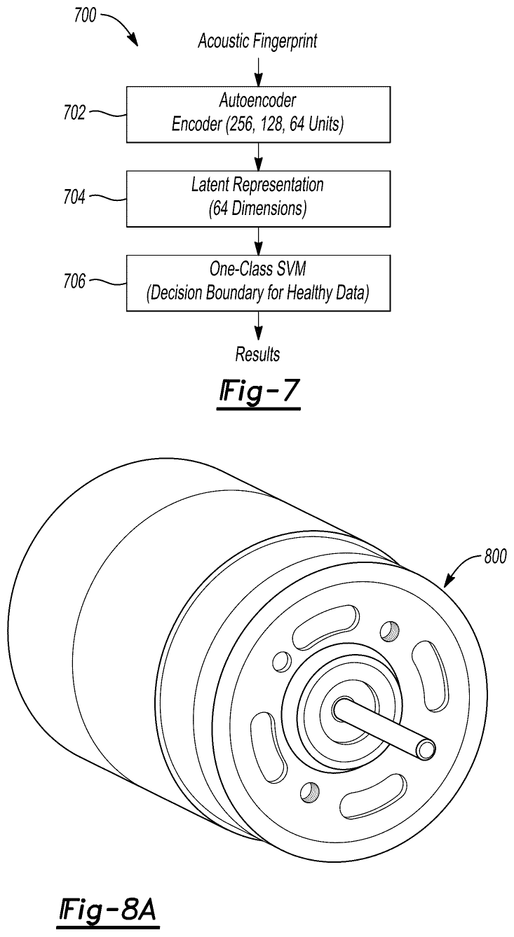

In scenarios where only healthy samples are available, the model may adopt an unsupervised learning approach to detect anomalies, identifying the anomalies based on deviation from a normal operational profile. See FIG. 7, a block diagram of a second fault detection model 700. This may be achieved through a combination of an Autoencoder 702 and a One-Class Support Vector Machine (“OC-SVM”) 706. Autoencoder 702 may be constructed with an encoder and decoder architecture. The encoder may comprise three fully connected layers with 256, 128, and 64 units, respectively, each followed by ReLU activations. The decoder may mirror the encoder with layers of 64, 128, and 256 units to reconstruct the input data. During training, the Autoencoder is trained on healthy samples, reducing or minimizing the Mean Squared Error (“MSE”) reconstruction loss, which allows it to learn a compact and noise-resilient latent representation of the acoustic fingerprint.

The latent representation 704 produced by the encoder, a 64-dimensional vector, is then passed to OC-SVM 706. OC-SVM 706 constructs a decision boundary around the healthy data in this latent space. During testing, new samples are first processed through Autoencoder 702, where their latent representations are generated by the encoder. These representations are evaluated by OC-SVM 706, which determines whether the data lies within the boundary of normal operational behavior. Samples that fall outside this boundary are flagged as anomalies, indicating potential deviations or faults, such as a fault in the assembly of connector half 100 and connector half 102.

This combined approach provides for Autoencoder 702 to effectively capture the distribution of healthy samples while OC-SVM 706 provides a robust anomaly detection mechanism. This method may be particularly effective in situations where faulty samples are scarce or unavailable, facilitating the detection of unseen anomalies based solely on normal operational data.

The performance of the noise reduction model may be evaluated using different metrics depending on the learning approach. For supervised learning (for example, as illustrated in FIG. 6), metrics such as accuracy, precision, recall, and F1-score may used to assess classification performance. For unsupervised learning (for example, as illustrated in FIG. 7), reconstruction error thresholds, anomaly detection rates, and false positive rates may be employed to evaluate the model's effectiveness. In both cases, the robustness of the model may be further validated by testing its ability to generalize across various operational conditions and noise levels.

To help provide adaptability and scalability, the architecture of the noise reduction model disclosed herein is modular, allowing it to be tailored to different types of industrial equipment, industrial processes, and varying levels of data availability. For example, in settings with high-dimensional and complex acoustic fingerprints, additional layers or advanced network structures, such as Transformers, can be incorporated to enhance feature extraction and representation. Conversely, for simpler applications, the model can be simplified to reduce computational overhead while maintaining accuracy.

The fault detection model's ability to handle both supervised and unsupervised scenarios makes it a versatile tool for industrial monitoring. By leveraging the acoustic fingerprint and advanced machine learning algorithms, the model provides a reliable and efficient solution for detecting faults and ensuring the operational integrity of industrial equipment and industrial processes, even in noisy and challenging environments.

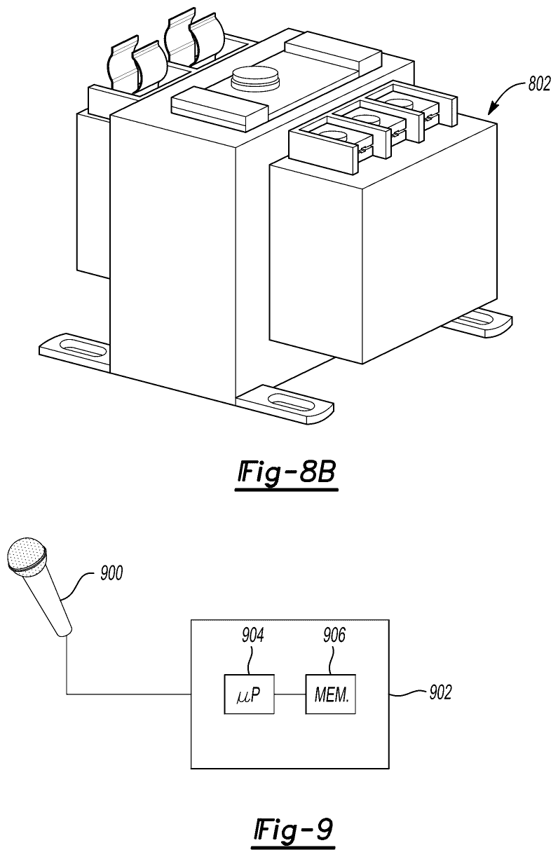

An application of the system and method disclosed herein may be to assess the operational quality of small electric motors, such as electric motor 800 (FIG. 8A) during production. This application can utilize both supervised and unsupervised learning approaches, depending on the availability of faulty motor data.

In the supervised learning approach, the noise reduction model may be trained using labeled data that includes both healthy and faulty sounds made by electric motor 800 during operation. This enables the system not only to detect motors with operational defects but also to classify the type of fault, such as unbalanced rotors or loose components. By providing precise fault identification, this approach supports targeted rework or repairs, reducing waste and production delays.

In the unsupervised learning approach, the model may be trained exclusively on healthy target sounds made by electric motor 800. The system identifies deviations from the learned normal profile as indicators of potential defects. While this unsupervised learning method may not be able to specify the type of defect, it effectively flags motors requiring further inspection, enhancing overall product quality.

An additional application of the system and method disclosed herein may be to monitor the acoustic emissions of power transformers, such as electric power transformer 802 (FIG. 8B), enabling early detection of operational issues. Acoustic signals from electric power transformer 802 are recorded during operation in real-world environments with significant background noise. These signals are processed through the noise reduction model to isolate the target sound. The clean signals are then analyzed using a fault detection model.

In this application, supervised learning may be employed when historical data with labeled fault types is available. This allows the system to classify specific issues such as partial discharges or loose windings. In scenarios where only healthy operational data is available, the unsupervised learning model detects deviations from the normal operational profile, signaling potential anomalies. This application enhances the reliability of transformer operations by identifying issues early, reducing the risk of downtime or failure.

These application scenarios illustrate the system's adaptability to diverse industrial settings. Whether applied to ensure connector assembly integrity, assess motor quality, or monitor transformer health, the system's robust noise reduction and fault detection capabilities provide accurate, efficient, and scalable solutions for maintaining high-quality standards and operational reliability in industrial environments.

The system of the present disclosure may be implemented as shown in FIG. 9. A microphone 900 or other suitable acoustic transducer may be coupled to a controller 902. Controller 902 may be a microprocessor based electronic controller containing a microcontroller 904 and memory 906. Controller 902 should be understood to have sufficient microcontroller resources (memory, inputs, outputs, peripherals, software, and the like) to perform the functions described in this disclosure. Further, the components and functions of controller 902 may be shared among a number of controllers that are networked together, some of which may be located on-site and some of which may be located in the cloud.

As a microprocessor-based controller, controller 902 may execute instructions, which may be software-implemented and which, when executed, may perform the functions described in this disclosure. Further, one or more of the instructions may comprise or initiate further instructions, which themselves may also be software-implemented.

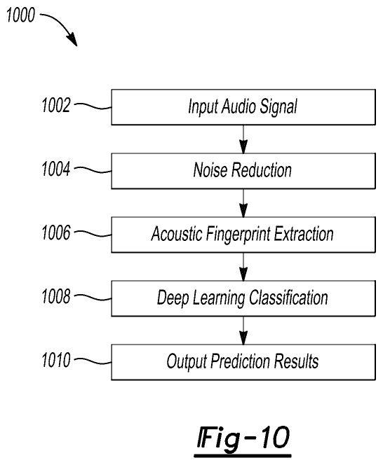

Referring to FIG. 10, the system and method disclosed herein provides a data processing pipeline 1000, which enables real-time processing of acoustic signals containing target sound signals and background noise for fault detection of equipment or a production process. As disclosed herein, the pipeline takes an input audio signal 1002, processes it through a noise reduction model 1004, extracts an acoustic fingerprint through a feature extraction module (block 1006), classifies the fingerprint using the result of deep learning (block 1008), and predicts whether the equipment or production process is faulty (block 1010), which may include, in the case of a fault, categorization of the fault.

In short, the system and method disclosed herein offers a cost-effective, reliable, and practical solution to industrial fault detection and quality control in real time. It allows users to conduct inline and end-of-line quality control testing and machine and equipment health monitoring in the presence of random noise interference.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

1. A method for fault detection and quality assessment using acoustic signals, comprising, through one or more controllers:
collecting acoustic signals from equipment undergoing inspection or a production process undergoing inspection, the acoustic signals containing background noise;
processing the acoustic signals through a noise reduction model to isolate target sound signals emitted by the equipment or the production process;
extracting acoustic fingerprints from the isolated target sound signals;
inputting the acoustic fingerprints into a fault detection model; and
classifying an operational state of or detecting anomalies in the equipment or production process based on an output of the fault detection model; and
through a data collection module:
collecting clean acoustic signals in a noise-controlled environment to form a baseline database;
collecting noisy acoustic signals in a production environment to form a test run dataset; and
aligning corresponding signals from the baseline database and the test run dataset.

2. The method of claim 1, further comprising training the fault detection model using supervised learning with faulty and healthy samples of the target sound signals.

3. The method of claim 1, further comprising training the fault detection model using unsupervised learning with only healthy samples of the target sound signals.

4. The method of claim 1, wherein the noise reduction model uses spectrogram representations of the acoustic signals as inputs and outputs denoised spectrograms for downstream processing.

5. The method of claim 1, wherein the acoustic fingerprints are generated by extracting features from at least two of time, frequency, and time-frequency domains, followed by dimensionality reduction.

6. The method of claim 1, wherein the target sound signals are emitted by assembly of an electrical connector.

7. The method of claim 4, wherein the target sound signals are emitted by operation of an electric motor.

8. The method of claim 5, wherein the target sound signals are emitted by operation of an electric power transformer.

9. A fault detection system for equipment or a production process that emits target sound signals, the system comprising:
a noise reduction model configured to isolate the target sound signals from background noise signals to result in isolated target sound signals;
a feature extraction module configured to generate acoustic fingerprints from the isolated target sound signals, wherein the feature extraction module is adapted to extract features in at least two of time, frequency, and time-frequency domains, and to standardize the extracted features for comparability;
a fault detection model trained to classify operational states or detect anomalies in the equipment or production process based on the acoustic fingerprints;
a data collection module configured to:
collect clean acoustic signals in a noise-controlled environment to form a baseline database;
collect noisy acoustic signals in a production environment to form a test run dataset; and
align corresponding signals from the baseline database and the test run dataset using correlation-based alignment techniques; and
a data processing pipeline enabling real-time processing of acoustic signals containing target sound signals from the equipment or production process and background noise signals for real-time fault detection of the equipment or production process.

10. The system of claim 9, wherein the noise reduction model comprises a two-dimensional convolutional neural network (“2D CNN”) encoder-decoder structure adapted to reduce or eliminate random background noise.

11. The system of claim 9, wherein the noise reduction model comprises a hybrid structure combining a 2D CNN and Long Short-Term Memory (“LSTM”) network adapted to reduce or eliminate periodic or dynamic background noise.

12. The system of claim 9, wherein the production process includes assembling an electrical connector.

13. The system of claim 9, wherein the fault detection model includes a supervised learning model trained with data comprising healthy and faulty samples of target sound signals, capable of classifying fault types.

14. The system of claim 9, wherein the fault detection model includes an unsupervised learning model trained on healthy samples but not on faulty samples of target sound signals, to identify anomalies based on deviation from a normal operational profile.

15. The system of claim 9, wherein the acoustic fingerprints are generated through a process including:
extracting multi-dimensional features from the isolated sound signals;
standardizing and fusing the features into a unified representation; and
reducing the dimensionality of the representation using Principal Component Analysis (“PCA”) to form a compact acoustic fingerprint.

16. The system of claim 9,
wherein the data collection module aligns the corresponding signals from the baseline database and the test run dataset using correlation-based alignment techniques.

17. The system of claim 9, wherein the noise reduction model is trained by reducing reconstruction errors between noisy and clean spectrograms using a mean-squared error loss function.

18. A fault detection system comprising:
a noise reduction model configured to isolate target sound signals from equipment or a production process from background noise, the noise reduction model further comprising a two-dimensional convolutional neural network (“2D CNN”) encoder-decoder structure adapted to reduce or eliminate random background noise, the 2D CNN encoder-decoder structure further including:
an encoder including:
a first convolutional layer followed by a first batch normalization and a first ReLU activation function;
a first pooling layer;
a second convolutional layer followed by a second batch normalization and a second ReLU activation function;
a second pooling layer operative to generate a flattened feature map; and
a fully-connected layer configured to map the flattened feature map to a latent feature space; and
a decoder including:
a fully-connected layer configured to reshape latent feature space into a feature map;
a transposed convolutional layer, followed by batch normalization and a third ReLU activation function;
a second transposed convolutional layer;
a regression layer; and
an inverse STFT;
a feature extraction module configured to generate acoustic fingerprints from the isolated target sound signals;
a fault detection model trained to classify operational states or detect anomalies in the equipment or production process based on the acoustic fingerprints; and
a data processing pipeline enabling real-time processing of acoustic signals for fault detection.

19. The fault detection system of claim 18, wherein the feature extraction module is operational to:
reduce audio noise from the isolated target sound signals to create reduced-noise target sound signals;
extract features from the reduced-noise target sound signals in at least two of time, frequency, and time-frequency domains;
normalize the features;
fuse the features by concatenating them into a multi-dimensional feature vector; and
reduce the dimensionality of the multi-dimensional feature vector using principal component analysis (“PCA”) to result in the acoustic fingerprints.

20. The fault detection system of claim 19, wherein the fault detection model is trained using unsupervised learning including the following:
an autoencoder further comprising an encoder and a decoder; and
a one-class support vector machine (“OC-SVM”).
